(19) United States
(12) Patent Application Publication
(10) Pub. No.: US 2005/0206883 A1
(43) Pub. Date: Sep. 22, 2005

(54) Single source, single camera inspection system

(76) Inventor: Wen Liang Gao, Fort Collins, CO (US)

Correspondence Address: PERMAN & GREEN, 425 POST ROAD, FAIRFIELD, CT, 06824, US

(21) Appl. No.: 10/805,902

(22) Filed: Mar. 22, 2004

(51) Int. Cl. G01N 21/88

(52) U.S. Cl. 356/237.1

(57) ABSTRACT

An inspection system includes a source for emitting a light beam, a sensor for capturing images of a target area, and an optical system for splitting the light beam into a plurality of paths for illuminating the target area. The optical system arranged such that a 2D image and a 3D image of the target area have the same optical path length from the target area to the sensor.

### BACKGROUND

1. Field of the Invention

The present invention relates generally to data acquisition for determining characteristics of an object and, in particular, to using a single source, single camera system for more effective object inspection.

2. Brief Description of Related Developments

Rapid and precise inspections of soldering and assembly processes of electronic devices have become important in the electronics manufacturing industry. The reduced size of components and solder connections, the resulting increased density of components on circuit boards, and the use of surface mount technology, where solder paste patterns, as well as solder joints are small, have increased both the importance and difficulty of high speed and accurate inspection of electronic devices and the electrical connections between devices.

High speed, non-contact measurements may be made with laser triangulation systems. In these types of systems, a laser source is directed at an object and the reflected light is detected by a sensor. The distance and the angle between the sensor and the object, and between the laser source and the object are known, allowing the spatial location of the point on the surface of the object to be calculated using simple trigonometry. By scanning a number of points, the surface of the object may be mapped. Scanning may be accomplished by moving the laser source, the object, the sensor, or any combination thereof.

Two typical configurations for simple systems having a single laser 2 and sensor 4 are shown in FIGS. 1A and 1B. Generally, these types of systems suffer from shadowing and occlusion problems. To overcome these shortcomings, two sensors or two laser sources may be employed, however this generally results in increased cost and complexity.

FIG. 2 shows an alternate solution that utilizes a single laser and sensor combination and provides a split three dimensional (3D) detection path, that is, laser light is reflected along two paths from a point on the object. Laser light from source 210 is projected onto an optical element 220 as shown by line 275 and directed to a point on an object 225. The laser light is reflected from the point along two paths 265, 270 to optical elements 230 and 235, respectively. From optical elements 230 and 235, the light is directed to camera sensor 240 along paths 245 and 250, respectively and a 3D image is captured by laser triangulation. In effect, this system provides two “views” of the point. One or more LED's 260 are used to illuminate the point on the object 225 for two dimensional (2D) imaging. Light from LED's 260 is projected onto optical element 220′ as shown by arrow 280 and directed to a point on object 225. The LED light is reflected through optical element 220 to camera sensor 240 along path 255 and a 2D image is captured by camera sensor 240. This system is disadvantageous in that there is a limited, short working distance due to the physical size of the sensor 240, which is typically about 6 mm without beam folding. There is also an optical path difference between the 2D and 3D optical paths in this system which would generally require optical compensation. Beam folding would aggravate this optical path difference. In addition, there are optical intensity losses caused by beam splitting.

### SUMMARY OF THE INVENTION

The present invention is directed to an inspection system, including a source for emitting a light beam, a sensor for capturing images of a target area, an optical system for splitting the light beam into a plurality of paths for illuminating the target area, the optical system arranged such that a 2D image and a 3D image of the target area have the same optical path length from the target area to the sensor.

In another embodiment, an inspection system includes a source for emitting a light beam, a sensor for capturing images of a target, and an optical system for splitting the light beam into a plurality of paths for illuminating the target, the optical system arranged such that a 2D image and a 3D image of the target appear in a same focal plane for capture by the sensor.

In still another embodiment, a method of inspection includes splitting a light beam into a plurality of paths, utilizing the plurality of paths to illuminating a target so that a 2D image and a 3D image of the target appear in the same focal plane, and capturing the 2D and 3D images with a sensor.

### BRIEF DESCRIPTION OF THE DRAWINGS

The foregoing aspects and other features of the disclosed embodiments are explained in the following description, taken in connection with the accompanying drawings, wherein:

FIGS. 1A and 1B show diagrams of simple, single laser, single camera prior art laser triangulation systems;

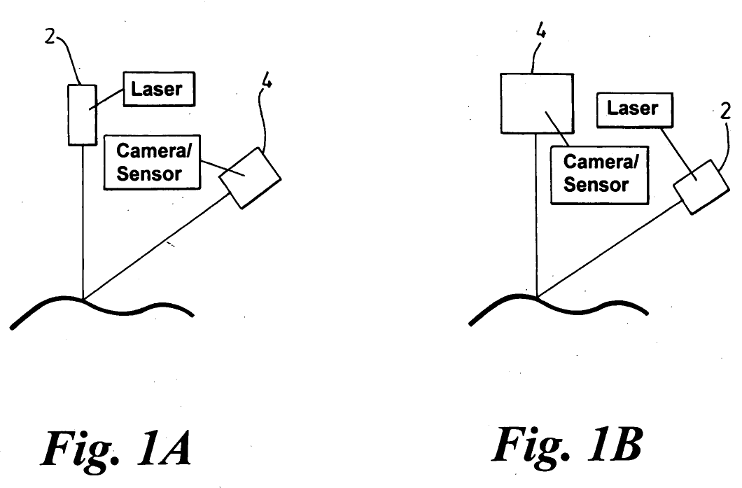

FIG. 2 is a diagram of another prior art laser triangulation system;

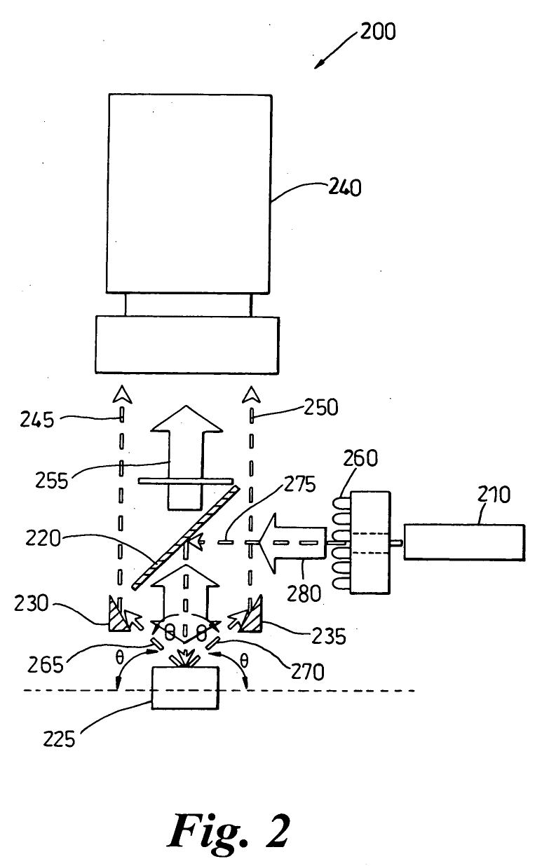

FIG. 3 is a diagram of a laser triangulation system according to the present invention; and

FIG. 4 is a diagram of another embodiment of a laser triangulation system according to the present invention.

### DETAILED DESCRIPTION OF THE EMBODIMENT(S)

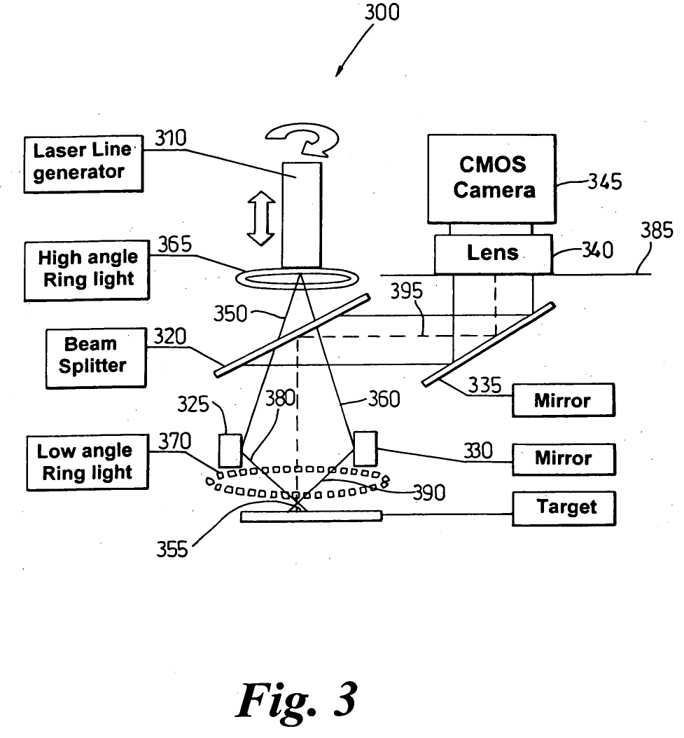

Referring to FIG. 3, a diagram of a system 300 incorporating features of the present invention is illustrated. Although the present invention will be described with reference to the embodiments shown in the drawings, it should be understood that the embodiments disclosed can be embodied in many alternate forms of embodiments. In addition, any suitable size, shape or type of elements or materials could be used.

The disclosed embodiments are directed to a system that includes a light source, a sensor for capturing images of a target, and an optical system for using the light source to illuminate the target.

It is a feature of the invention that the optical system splits a beam from the source into a plurality of paths which are then used to illuminate the target in order to mitigate disadvantages encountered with prior art systems.

It is another feature of the present invention that the system components are arranged such that both 2D and 3D images of the target have the same optical path length between the target and the sensor.

It is another feature of the present invention that the system components are arranged such that both 2D and 3D images of the target appear in the same focal plane for capture by the sensor.

As shown in FIG. 3, the system 300 generally includes a source 310, a beam splitter 320, a first mirror 325, a second mirror 330, a third mirror 335, a lens 340 and a camera 345.

For 3D imaging, light from the source 310 is directed angularly toward the first and second mirrors 325, 330 providing a split source path. Thus, the light from the source travels along a first path 350 through beam splitter 320 impinging on first mirror 325 and then along a second path 380 onto a target area 355. The source light also travels along a third path 360 impinging on second mirror 330 and then along a fourth path 390 onto target area 355. As a result, first and second mirrors 325, 330 comprise an optical system that provides a number of beams, in this embodiment, two, used to illuminate the target area 355 from different directions, reducing any shadowing or occlusion problems. In this embodiment, mirrors 325 and 330 are positioned such that the optical lengths of paths 350 and 360 are the same, and the optical lengths of paths 380 and 390 are the same.

A 3D image of target area 355 is reflected from beam splitter 320 to third mirror 335 and collected by camera 345 through lens 340. The 3D imaging optical path is shown by dotted line 395.

The system generally includes additional light sources for 2D imaging of target area 355. In this embodiment, a high angle ring light 365 and a low angle ring light 370 are used for this purpose. Light from high angle ring light 365, low angle ring light 370, or both illuminates target area 355. The 2D image of target area 355, like the 3D image, travels along optical path 395 to camera 345.

Because of the particular arrangement of components, and in particular, because optical path 395 from the target area 355 to the camera 345 is the same for both 2D and 3D imaging, there is no optical path difference between the 2D and 3D image paths. The particular arrangement also provides the 2D and 3D images in the same focal plane, an example of which is designated 385 in FIG. 3.

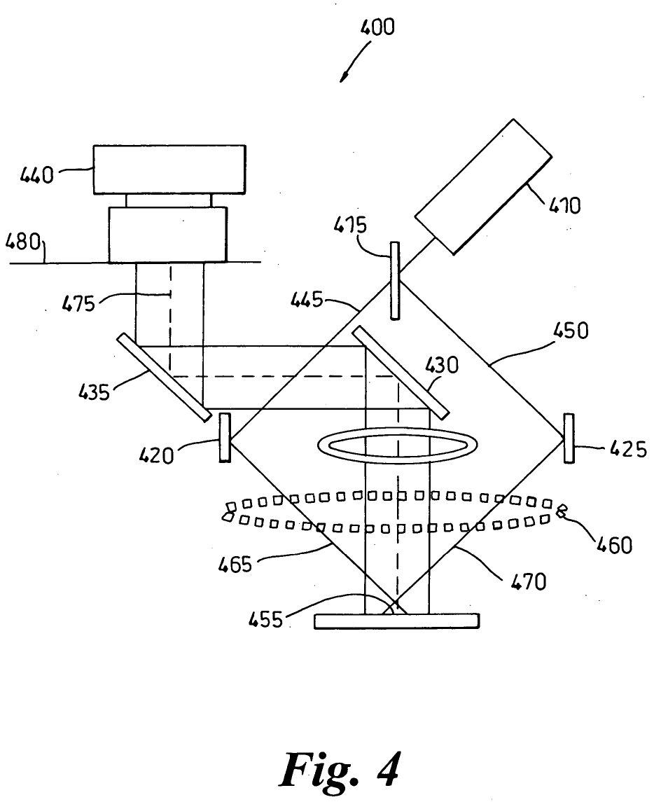

Another embodiment of the present invention is shown in FIG. 4. This embodiment includes a source 410, a beam splitter 415, first, second, third and fourth mirrors, 420, 425, 430, 435, respectively and a sensor 440.

For 3D imaging, light from source 410 is split by beam splitter 415 and directed to the first and second mirrors 420, 425, along first and third paths 445 and 450, respectively. The beams from the first and second mirrors 420, 425 then travel along second and fourth paths 465 and 470, respectively, to impinge on target area 455. In this embodiment beam splitter 415, and first and second mirrors 420, 425 comprise an optical system that provides dual illumination beams.

In this embodiment, beam splitter 415 and first and second mirrors 420, 425 are positioned such that the optical distance of first, second, third, and fourth paths 445, 450, 465, and 470 are equal. In other embodiments, beam splitter 415 and first and second mirrors 420, 425 may be positioned such that the optical length of first and third paths 445, 450 are the same, and the optical length of second and fourth paths 465, 470 are the same, but the optical length of the first and third paths 445, 460 need not correspond to the optical length of second and fourth paths 465, 470.

A 3D image of target area 455 travels along path 475 and is reflected by third mirror 430, positioned so as not to interfere with first and third paths 445 and 450. The 3D image proceeds to fourth mirror 435 and is captured by sensor 440.

2D illumination of the target area 455 may be provided by a high or low angle ring light 460 placed between third mirror 430 and target area 455. Light from ring light 360 illuminates target area 455 and, like the 3D image, a 2D image is provided along path 475 to sensor 440.

Because of the placement and characteristics of the optical components of this embodiment, the optical path 475 for both the 2D and 3D image between the target area 455 and the sensor 440 is the same. The optical components are also arranged such that the 2D and 3D images are in the same focal plane, an example of which is designated 480 in FIG. 4. This embodiment is also advantageous because the component arrangement, including beam splitter 415, and first, second, third, and fourth mirrors 420, 425, 430, 435, provides a system having no appreciable optical intensity loss. As can be seen from FIG. 4, this is accomplished by the beam splitter 415, and first and second mirrors 420, 425 being positioned so that the output of the source 410 does not pass through mirror 430.

According to the present invention, the embodiments shown in FIGS. 3 and 4 are advantageous in that the 2D and 3D images are in the same focal plane, requiring no compensation when switching between 2D and 3D imaging. Sensor size does not limit the working distance of the system and, due to the embodiments' geometry, low angle 2D lighting may easily be implemented.

Sources 310, 410 may be laser line generators or other sources of electromagnetic radiation suitable for use with the disclosed embodiments.

Target areas 355, 455 may in some instances be a point or a number of points.

In the embodiment shown in FIG. 3, mirrors 325, 330 may be adjustable horizontally, vertically, and angularly to provide illumination at different angles and from various locations. Mirrors 420, 425 shown in FIG. 4 may be adjustable in the same manner.

In the embodiments shown in FIGS. 3 and 4, light from the source is generally split into two beams for illuminating the target area from two directions. It should be understood that light from the source may be split into any suitable number of beams for illuminating the target areas from any number of directions.

Sensors 345, 440 may be cameras, and in particular may be addressable cameras, for example using CMOS technology and may allow for a high speed 3-D read out. Sensors 345, 350 may be cameras that are switchable between 2 dimensionable and 3 dimensionable imaging. In some embodiments sensors 345, 440 may be color cameras or systems 300 and 400 may include filters to separate 2-D and 3-D images.

Each of the embodiments shown in FIGS. 3 and 4 may include additional optical elements as required.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. An inspection system comprising:
a source for emitting a light beam;
a sensor for capturing images of a target area; and
an optical system for splitting the light beam into a plurality of paths for illuminating the target area, the optical system arranged such that a 2D image and a 3D image of the target area have the same optical path length from the target area to the sensor.

2. The inspection system of claim 1, wherein the source is a laser line generator.

3. The inspection system of claim 1, wherein the sensor is an addressable camera.

4. The inspection system of claim 1, wherein the target area is a point.

5. The inspection system of claim 1, wherein the optical system comprises first and second mirrors arranged so that the light beam impinges on the first and second mirrors and is reflected onto the target from the first mirror in one direction and from the second mirror in another direction.

6. The inspection system of claim 1, wherein the first and second mirrors are adjustable horizontally, vertically, and angularly.

7. An inspection system comprising:
a source for emitting a light beam;
a sensor for capturing images of a target; and
an optical system for splitting the light beam into a plurality of paths for illuminating the target, the optical system arranged such that a 2D image and a 3D image of the target appear in a same focal plane for capture by the sensor.

8. The inspection system of claim 7, wherein the source is a laser line generator.

9. The inspection system of claim 7, wherein the sensor is an addressable camera.

10. The inspection system of claim 7, wherein the target area is a point.

11. The inspection system of claim 7, wherein the optical system comprises first and second mirrors arranged so that the light beam impinges on the first and second mirrors and is reflected onto the target from the first mirror in one direction and from the second mirror in another direction.

12. The inspection system of claim 7, wherein the first and second mirrors are adjustable horizontally, vertically, and angularly.

13. A method of inspection comprising:
splitting a light beam into a plurality of paths;
utilizing the plurality of paths to illuminating a target so that a 2D image and a 3D image of the target appear in the same focal plane; and
capturing the 2D and 3D images with a sensor.
